(19) United States
(12) Patent Application Publication
(10) Pub. No.: US 2005/0244322 A1
(43) Pub. Date: Nov. 3, 2005

(54) Hollow-structured mesoporous silica material and preparation process

(76) Inventors: Jianfeng Chen, Beijing (CN); Runjing Liu, Beijing (CN); Yun Jimmy, Beijing (CN); Zhigang Shen, Beijing (CN)

Correspondence Address: HASSE & NESBITT LLC, 7550 CENTRAL PARK BLVD., MASON, OH, 45040, US

(21) Appl. No.: 11/171,152

(22) Filed: Jun. 30, 2005

(30) Foreign Application Priority Data
Dec. 30, 2002 (CN) 02160383.9

(51) Int. Cl. C01B 33/12

(52) U.S. Cl. 423/335

(57) ABSTRACT

A hollow-structured mesoporous silica material composed of hollow silica particles that have a shell having radial-arrayed channels, and a process for its preparation. The thin-shell type of mesoporous materials with different morphologies are prepared by growing and synthesizing mesoporous silica on the surface of calcium carbonate nanoparticles with different shapes as inorganic templates, and then removing the inorganic templates. The hollow-structure mesoporous silica material can be used in many fields such as the preparation of catalyst, pesticide and optical fiber.

### FIELD OF THE INVENTION

The present invention relates to a silica-based mesoporous material and a preparation process therefore. Specifically, the present invention relates to a hollow-structured mesoporous silica material and a preparation process therefore. More specifically, the present invention relates to a hollow-structured mesoporous silica material having specific channel arrays and a preparation process therefore.

### BACKGROUND OF THE INVENTION

Silica, as an inorganic porous material, is widely used in the fields of rubber, pesticide, medicine, paper making, plastic processing, paint, insulation, thermal insulation and catalysis, due to its particular properties, such as high purity, low density, large specific surface area, and hydrogen bonds with varying strength formed between surface silanol groups and active silane bonds.

According to the definition of the International Union of Pure and Applied Chemistry (IUPAC), molecular sieves with pore diameters of less than about 2.0 nm are defined as microporous molecular sieves, and molecular sieves with pore diameters ranging from 2.0 to 50 nm are defined as mesoporous molecular sieves. The scientists at Mobil Corporation in 1992 discovered the M41S family (MCM-41, MCM-48, MCM-50) of silica-based mesoporous molecular sieves, which started a new epoch in the molecular sieve area (See, Beck J. S., Vartuli J. C., Roth W. J., A new family of mesoporous molecular sieves prepared with liquid template, J. Am. Chem. Soc., 1992, 114:10834-10843). Compared with conventional microporous molecular sieves, mesoporous molecular sieves have both larger pore sizes and specific surface areas (1000 m²/g) and shell thickness, and hence have higher chemical and thermal stabilities. Therefore, the discovery of the material gives rise to a lot of attention from researchers in many fields of heterogeneous catalysis, adsorption and advanced inorganic materials.

Increasing innovations of synthesis techniques in the recent two years have generated silica-based molecular sieve series such as HMS, MSU and SBA. Subsequently, the occurrence of many non-silica based mesoporous materials such as Al₂O₃, Fe₂O₃, WO₃, V₂O₅, TiO₂ and ZrO₂, partial metallic sulfides, phosphate molecular sieves, and the above-mentioned silica-based mesoporous molecular sieve derivatives with metal heteroatoms results in an increasing development of the research on mesoporous molecular sieves and an extension of regular pore diameters of molecular sieves from micropore to mesopore. See, for example, Yang P., Zhao D., Margolese D. I., Generalized synthesis of large pore mesoporous metal oxides with semicrystalline frameworks, Nature, 1998, 396:152-155; and Holland B. T., Blanford C. F., Stein A., Synthesis of macroporous materials with highly ordered three-dimensional arrays of spheroidal voids, Science, 1998, 281:538-540. In the field of heterogeneous catalysis, mesoporous molecular sieves as catalysts or catalyst supports not only exhibit great potential applications in the catalysis of heavy residual oil and barrel bottom oil in crude oil processing, but also provide a more economical and less-polluting technique pathway for macromolecule catalysis, adsorption and separation, which are difficult to realize for zeolite molecular sieves. See, for example, Beck J. S., Socha R. S., Shihaabi D. S., U.S. Pat. No. 5,143,707 (1993); and Feng X., Fryxell G. C., Wang L. Q., Science, 1997, 276: 923-926, both which are incorporated herein by reference.

In addition, mesoporous materials with controllable and regular nano-sized pores can be used as a micro-reactor for nanoparticles, which provides an important material foundation for the investigation on many special performances of nanomaterials, such as small-scale effects, surface effects and quantum effects. For example, the loading and synthesis of semiconductors such as CdS and GaAs in mesoporous materials will have an important role in many aspects of optical communication, information storage and data processing. The assembly of nanoparticles with mesoporous materials not only manifests many inherent characteristics of nanoparticles, but also generates some new particular properties such as mesoporous fluorescence enhanced effects, optical nonlinear enhanced effects and abnormal magnetism, which are not possessed by nanoparticles and mesoporous materials. Furthermore, some performances can be controlled by design according to our own wish. For example, the location of optical absorption rims and absorption bands can be adjusted greatly by controlling the dimension of nanoparticles, surface state and pore diameters and porosity of mesoporous materials, thereby forming composite mesoporous materials and generating novel functional materials. Such mesoporous materials loading electron-transmitted filaments or molecule leads, such as regularly arrayed carbon filaments loaded in MCM-41, will build a foundation for the research and development of future microelectron and photoelectric devices. The research on mesoporous materials thus has become interesting in the world and generated a new aspect for multidiscipline in recent years.

The mesoporous materials are synthesized through the self-assembly process in the world, which can be classified into two stages: (1) growth of the precursor of organic/inorganic liquid crystal phases, in which organic/inorganic liquid crystal textural phases with nano-sized lattice constants are formed by self-assembling of surfactants having amphiphilic groups, i.e., having both hydrophilic and hydrophobic groups with polymerizable inorganic monomer molecules or oligomer thereof (inorganic source) under certain circumstance; and (2) formation of mesoporous pores (mesopores), in which the mesoporous channels are formed by the remained space which is obtained by removing surfactants through high temperature or chemical methods.

At present, many applications of mesoporous materials need preparation of film shape. Recently, mesoporous materials with specific morphologies are reported in the published literatures. For example, Yang et al. prepared oriented film of mesoporous silica having channels parallel to mica surface by adopting mica as support. (Yang H, Kuperman A, Coombs N., Suzan Mamlche-Afara & Geoffrey A. Ozin, Synthesis of oriented film of mesoporous silica on mica, Nature, 1996, 379: 703-705.) Other mesoporous materials with various states, such as mesoporous silica fibers, mesoporous silica spheres with diameters of several millimeters and non-oriented mesoporous films with a thickness of 75 nm formed on the surface of nonporous silica spheres with a diameter of 420 nm have been described. (Whittingham M S, Current Opinion in Solid State & Mater. Sci., 1996, 1, 227.) Owing to their channels parallel to the surfaces of the support, the internal diffusion resistance of the mesoporous material will be increased greatly.

The main problem in the research on mesoporous materials is that much attention is mainly paid to MCM-41 and less research on other mesoporous materials. The previous investigation indicated that there is a larger internal diffusion resistance in its one-dimension channels, which is confirmed by estimating the Knudsen diffusion coefficient D_{K}=7.3×10⁻² cm²/s (in terms of methane). Since the internal diffusion resistance increases, mass transfer becomes difficult. It is very necessary to develop new synthetic systems and routes for preparing silica-based mesoporous materials with various morphologies including films, fibers and microspheres.

Accordingly, one aspect of the present invention is to provide a mesoporous silica material having specific channel arrays. A further aspect of the present invention is to provide a preparation process for the above-mentioned mesoporous silica material.

### SUMMARY OF THE INVENTION

The present invention relates to a hollow-structured mesoporous silica material comprising a hollow silica particle that has a shell having a plurality of channels oriented substantially perpendicular to the inner surface of the shell.

The present invention further relates to a process for preparation of hollow-structured mesoporous silica material, in which thin-shell type of mesoporous materials with different morphologies are prepared by growing and synthesizing mesoporous silica on the surface of calcium carbonate nanoparticles with different shapes as inorganic templates, and then removing the inorganic templates to prepare mesoporous materials with different hollow shapes.

Specifically, the present invention relates to a process for preparation of the hollow-structured mesoporous silica material, comprising the steps of:
(1) adding a surfactant that can form rod-shaped micelles into an aqueous suspension of inorganic templates made from an inorganic salt selected from the group consisting of calcium carbonate, magnesium carbonate and barium carbonate, and then adding an organic solvent;
(2) adding a source of silicon selected from organic silicate, such as tetraethylorthosilicate (TEOS), and inorganic silicon, such as sodium silicate, into the mixture obtained in the step (1) under an alkaline condition;
(3) filtering, the mixture obtained in step (2), then drying and calcinating the filtrate, to obtain the above-mentioned mesoporous silica material comprising the inorganic template; and
(4) adding the mesoporous silica material comprising the inorganic template into acid to produce the hollow-structured mesoporous silica.

More specifically, the invention relates to a process for preparation of the above-mentioned hollow-structured mesoporous silica material, comprising the steps of:
(1) adding surfactant of 1.5 to 30% by weight into a suspension of inorganic templates selected from the group consisting of calcium carbonate, magnesium carbonate and barium carbonate, and then adding a certain amount of organic solvent such as ethanol or methanol;
(2) adding a silicon source (including organic silicate esters such as tetraethylorthosilicate (TEOS) or inorganic silicon such as sodium silicate) into the mixture obtained in the step (1) under an alkaline condition, wherein the shells of mesopores are formed by depositing the hydrolysate or aggregate of added silicon source on the hexagonal arrays formed of the surfactants, and covering on rod-shaped micelles formed of the surfactants;
(3) filtering the mixture obtained in step (2), then drying and calcinating the filtrate, to obtain the mesoporous products having a core of inorganic template therein; and
(4) adding the mesoporous products of step (3) into hydrochloric acid to gain hollow-structured mesoporous silica.

The present invention further relates to the use of the hollow-structured mesoporous silica material in many fields such as preparation of catalyst, pesticide and optical fiber.

### BRIEF DESCRIPTION OF THE DRAWINGS

FIG. 1 shows a high resolution transmission electron microscopy (HRTEM) image of a spherical hollow-structured mesoporous silica material of the present invention.

FIG. 2 shows a scanning electron microscopy (SEM) image of a spherical hollow-structured mesoporous silica material of the present invention.

FIG. 3 shows a local HRTEM image of the spherical hollow-structured mesoporous silica material of FIG. 1.

FIG. 4 shows a TEM image of a tubular mesoporous silica material of the present invention.

FIG. 5 shows a local HRTEM image of tubular mesoporous silica material of FIG. 4.

FIG. 6 shows a SEM image of the tubular mesoporous silica material of FIG. 4.

FIG. 7 shows the pore size distribution for the spherical hollow-structured mesoporous silica material of FIG. 1.

FIG. 8 shows adsorption isotherms for the spherical hollow-structured mesoporous silica material of FIG. 1.

FIG. 9 shows a TEM image of calcium carbonate nanoparticles as inorganic templates for preparing a mesoporous silica material of the present invention, in which calcium carbonate is synthesized by high gravity reactive precipitation method.

FIG. 10 shows adsorption isotherms for the tubular mesoporous silica material of FIG. 4.

FIG. 11 shows a schematic procedure of modes for growing mesoporous films on matrix.

FIG. 12 shows the complete procedure for synthesizing hollow mesoporous silica material.

### DETAILED DESCRIPTION OF THE INVENTION

The present invention provides a hollow-structured mesoporous silica material comprising a hollow silica particle that has a shell having a plurality of channels oriented substantially perpendicular to the inner surface of the shell.

The hollow-structured mesoporous silica material can have different shapes such as spherical, needle-like and cubic shape, depending on the shapes of the inorganic templates used for preparing the mesoporous silica material.

The mesoporous silica material can have a wide range of particle diameters of, for example, from 10 to about 500 nm, preferably from 40 to about 150 nm and more preferably from 50 to about 120 nm, which depends on the diameters of inorganic template particles for preparing the mesoporous material.

The mesoporous silica material can have a shell with a substantially uniform thickness of from 5 to about 500 nm, preferably from 8 to about 20 nm and more preferably from 10 to about 15 nm.

The mesoporous silica material can have an average pore diameter of from 2 to about 50 nm, preferably from 2 to about 10 nm and more preferably from 2 to about 5 nm.

The present invention further provides a process for preparation of the above-mentioned mesoporous silica material, in which thin-shell type of mesoporous materials with different morphologies are prepared by growing and synthesizing mesoporous silica on the surface of calcium carbonate nanoparticles with different shapes as inorganic templates, and then removing the inorganic templates.

Specifically, the present invention provides a process for preparation hollow-structured mesoporous silica material, comprising the steps of:
(1) adding a certain amount of surfactant into a suspension of inorganic templates;
(2) adding organic silicon source such as orthosilicate ester into the mixture obtained in step (1) under an alkaline condition, so as to cover the surfactants;
(3) filtering the mixture obtained in step (2), then drying and calcinating the filtrate, to obtain said mesoporous products having a core of inorganic template therein; and
(4) adding the mesoporous product of step (3) into an acid, such as hydrochloric acid, to gain the hollow-structured mesaporous silica.

The organic solvent is typically ethanol or methanol, or the like.

The inorganic templates used in the present invention are selected from the group consisting of calcium carbonate, magnesium carbonate and barium carbonate, which can have various shapes, such as cubic, spindle, petal-like, needle-like, laminar, spherical and fibroid shapes.

A spindle-shaped calcium carbonate is described in Japanese published patent applications 5-238730, 59-26927, 1-301510 and 2-243513, in which calcium carbonate with desired shapes can be prepared by adding an agent for controlling crystal form to the conventional stirring vessel or bubbling tower.

A needle-like calcium carbonate is described in U.S. Pat. No. 5,164,172, and can be obtained from calcium hydroxide suspension in the presence of crystal seeds of needle-like calcium carbonate and phosphoric acid by carbonization process. Furthermore, there have been a large number of patent documents that describe the preparation of various calcium carbonates, which is thinner, more controllable and has more complete shapes, such as Japanese published patent applications 59-223225 and 62-278123.

A process for preparing superfine calcium carbonate in high-gravity environment generated by a rotating packed bed (RPB) reactor has been developed by Beijing University of Chemical Technology, for example, those described in Chinese patent ZL95105343.4, and Chinese patent applications 00100355.0 and 00129696.5, which are incorporated herein by reference.

The synthetic procedure for calcium carbonate of different shapes used herein can be found in Chinese patent applications 01145312.5 and 02105389.9. Calcium carbonate with a narrow size distribution and different shapes can be synthesized by adjusting the speed of RPB and other process conditions, such as the concentrations of initial reactants, temperature, pH values and the selection of the agent for controlling crystal formation, to control nucleation and growth of calcium carbonate, and hence finely controlling the mixing characteristics of carbonation reaction.

In Chinese patent application 01145312.5, calcium carbonate of different shapes, such as spindle, petal-like, fibroid, laminar, needle-like and spherical shapes, were synthesized by carbonizing calcium hydroxide and carbon dioxide under a high gravity environment, for example in a RPB reactor. A superfine whisker-like calcium carbonate was provided in Chinese patent application 02105389.9. The above-mentioned patent documents are incorporated herein by reference.

According to the process in the present invention, the inorganic template suspension used has a concentration of from 1.5 to about 25% by weight and preferably from 5 to about 10% by weight of the inorganic template.

The surfactant used, as an organic template, can have a concentration of from 1.5 to about 20%, relative to the weight of the mixture.

According to the process in the present invention, the surfactant can be any surfactant suitable for preparing mesoporous materials in the art, for example those described in J. Inorg. Mater. 1999, 14(3): 333-342, including but not limited to, the surfactants having amphiphilic groups, preferably quaternary ammonium surfactant, preferably cetyltrimethylammonium halide and more preferably cetyltrimethylammonium bromide (CTMAB). A typical surfactant can be selected from the group consisting of a cationic surfactant of long-chain alkyl quaternary ammonium salts with low molecular weight CₙH₂ₙ₊₁NMe₃X, wherein n=10 to about 22, X=Br—, Cl— or OH—; a surfactant with multi-functional groups NH₂(CH₂)ₙNH₂, wherein n=10 to about 22; and a surfactant with high molecular weight selected from PEO-PPO-PEO, and a nonionic Gemini surfactant.

According to the process in the present invention, the surfactant used herein can have a wide range of concentration, including the concentration for forming spherical or rod-shaped micelles, such as from 1.5 to about 20%, preferably from 1.8 to about 10% and more preferably from 2.0 to about 5%, relative to the weight of the suspension.

The ratio of the inorganic template and the surfactant is from 1 to about 20, preferably from 2 to about 10 and more preferably from 3 to about 5.

The ratio of silicon source (in terms of the weight of silica) and the inorganic template is from 0.05 to about 300, preferably from 0.1 to about 10 and more preferably from 0.15 to about 5.

In the process of the invention, the pH value can be controlled in a range of from 8 to about 14, preferably from 10 to about 14 and more preferably from 12 to about 14 by adding an alkali substance including sodium hydroxide, potassium hydroxide, lithium hydroxide, urea, ammonium bicarbonate, aqueous ammonia, ammonium chloride, and the like. The reaction temperature is typically from 10 to about 200° C. and preferably from 25 to about 150° C. The reaction time is typically from 10 minutes to 36 hours and the calcination time is typically from 0.2 hours to 100 hours. According to an embodiment of the invention, thin-shell type of mesoporous nanospheres, which are synthesized by adopting calcium carbonate with a diameter of about from 40 to about 50 nm as the inorganic template, has a diameter of about 60 nm, a specific surface area α_{BET} of 1016.72 m²/g, an average pore size of 3.94 nm and a pore volume of 1.002 cm³/g.

According to another embodiment of the invention, mesoporous hollow tubes, which are synthesized by adopting needle-like calcium carbonate with a diameter of 200-300 nm and an aspect ratio of about 5 as inorganic templates, and CTAB with a concentration of 2%, have a shell with thickness of about 40 nm, specific surface area aBET of 565.9 m²/g, a pore volume of 0.6218 cm³/g and an average pore size of 4.39 nm.

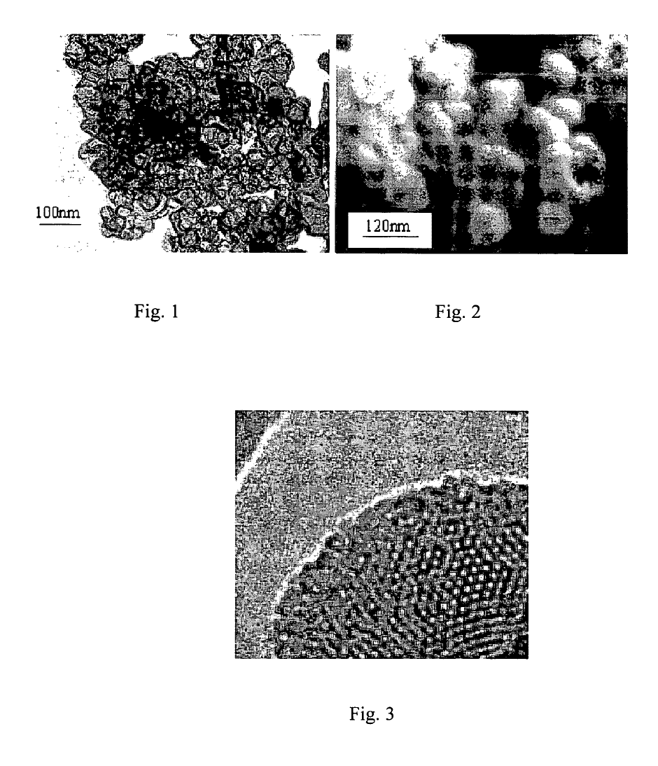

The thin-shell type of mesoporous nanospheres according to the invention was characterized by transmission electron microscopy (FE-TEM, JEOL JEM-2010F, Acceleration: 200 KV) and scanning electron microscopy (FEG-SEM, Resolution: 1.5 nm), as shown in FIGS. 1-3.

It can be seen from FIGS. 1 and 2 that the mesoporous nanospheres have an average diameter of about 60 nm. The sample agglomerated seriously, although it was dispersed in ethanol by sonication before measurement. The presence of hollow structure is further confirmed by some broken spheres in the SEM images. In addition, it can be seen from FIG. 3, showing the local TEM image of mesoporous nanospheres, that there exist mesopores with hexagonal arrays formed by self-assembly.

The pore diameter, D, of the mesopores at 2θ=2.4° on crystal plane (100) is 3.58 nm, which is obtained by measuring the Small-angle X-ray diffraction (XRD) pattern of hollow silica nanospheres with a diffraction meter (SIEMENS D5005D) with CuKα radiation of 0.15406 nm in wavelength at 40 kV, 100 mA at an interval of 0.02°.

The pore size distribution of the mesoporous hollow spheres was measured with ASAP 2010 Surface Area Analyzer (Micromeritics Instrument Corporation, USA), as shown in FIG. 7.

The mesoporous nanospheres have a narrow pore size distribution, as shown in FIG. 7 which shows the pore size distribution of mesoporous nanospheres. According to BET method, the surface area, α_{BET}, and the pore volume, V_{g}, of the sample are 1016.72 m²/g and 1 cm³/g, respectively, and hence the average pore diameter, D=⁴V_{g}/a, is 3.94 nm, which is 0.36 nm larger than the result (D=3.58 nm) obtained from XRD data. There are probably two reasons for this. First, the calculated value of pore diameter is obtained from ideal conditions while some disordered phases exist in fact, which leads to underestimation of the dimension of mesopores. Second, the possible reason is that the measured pore volume in addition to mesoporous volume includes the volume of channels among thin-shell mesoporous nanospheres, which results in the larger average diameter measured by BET method than that obtained from XRD calculation. The average diameter obtained by BJH method is 4.3 nm, which is larger than that obtained by BET method.

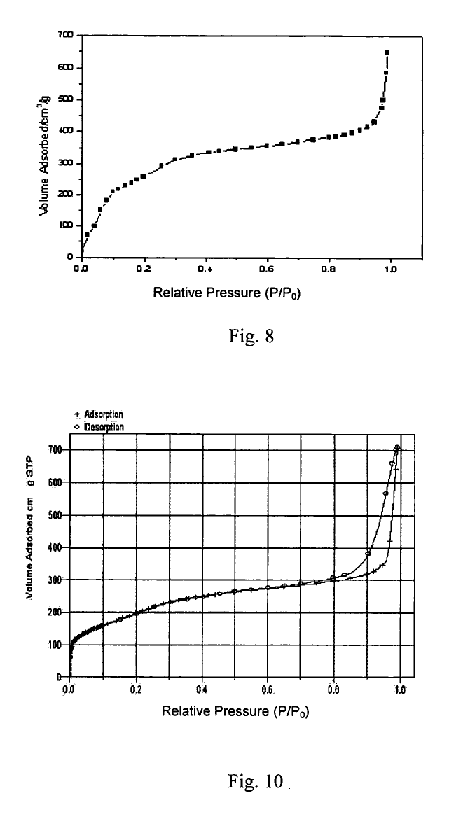

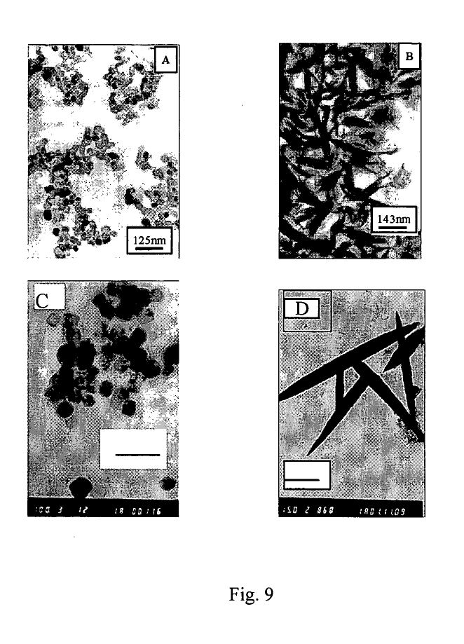

FIG. 8 shows N₂ adsorption isotherms at a temperature of 77.39° K for thin-shell mesoporous nanospheres of the present invention. It can seen from FIG. 8 that when the relative pressure is lower (i.e., P/P₀≦0.1), the amount of adsorption increases quickly with the increase of P/P₀; and when P/P₀ is no less than 0.1, the adsorption isotherm becomes gradual; and when P/P₀ is about 0.2-0.3, the amount of adsorption has a weak abrupt increase due to a capillary condensation of N₂ molecules in mesopores; and there is no steep peak of the amount of adsorption when P/P₀ is about 0.3-0.4, which may lead to different adsorption isotherms; and when P/P₀ is larger or equal to 0.3, the curve becomes smooth gradually; and when P/P₀ is close to 1, N₂ is condensed completely.

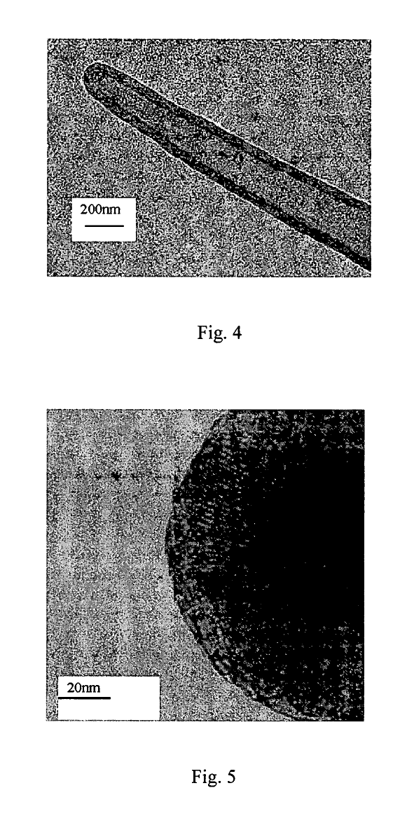

The mesoporous hollow tube according to the invention was characterized by transmission electron microscopy (FE-TEM, JEOL JEM-2010F, Acceleration: 200 KV) and scanning electron microscopy (PEG-SEM, Resolution: 1.5 nm), as shown in FIG. 4.

As shown in FIG. 4, the thus prepared hollow tubes have an inner diameter of approximately 200-300 nm and have a shell with thickness of about 40 nm. The aspect ratio of the hollow tubes depends on that of needle-like calcium carbonate as the inorganic template. The aspect ratio of the calcium carbonate used in the experiment is about 5.

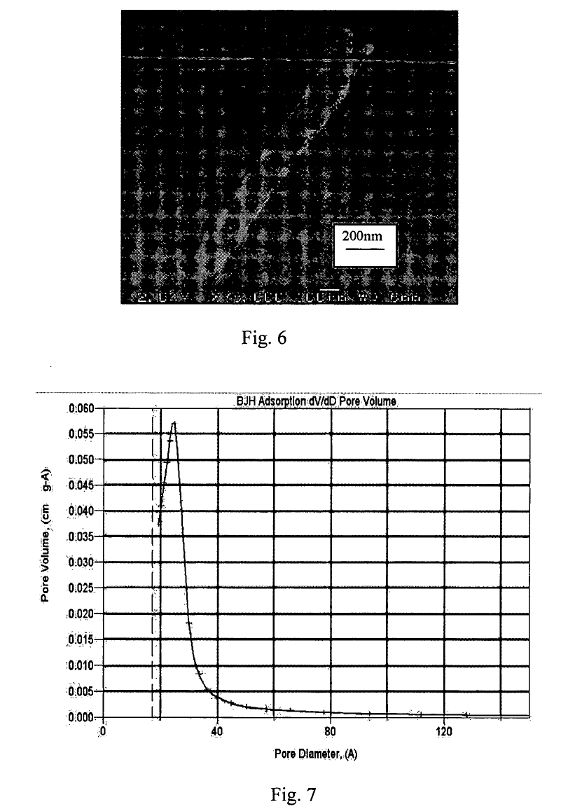

FIG. 5 shows an HRTEM image of the mesoporous hollow tubes viewed in the axial direction. The mesoporous channels, which are orderly-arrayed, wheel-shaped stripes can be observed extending in a radial direction from the hollow tube. And it can be seen that the tubular material is a hollow material from the top of hollow tube in FIG. 6.

The N₂ adsorption and desorption isotherms of mesoporous hollow tube in the invention were measured on an ASAP 2010 Surface Area Analyzer (Micromeritics Instrument Corporation, USA), as shown in FIG. 10.

As shown in FIG. 10, when the relative pressures, P/P₀, is lower, the amount of adsorption of N₂ increases quickly with the increase of P/P₀; and when P/P₀ is about 0.2-0.3, the amount of adsorption has a weak abrupt increase due to a capillary condensation of N₂ molecules in mesopores; and, thereafter, the curve becomes gradual; and when P/P₀ is close to 1, N₂ is condensed completely. The hysteresis loop occurs in the process of N₂ adsorption and desorption owing to a capillary action.

There are three kinds of modes for growing mesoporous films on matrix as follows:

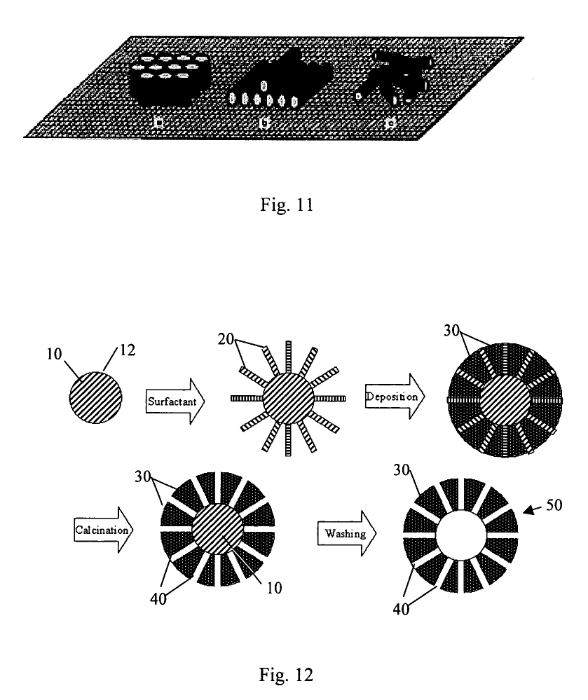

In view of the lowest energy principle, it is easy to carry out the two growing modes shown in FIG. 11(b-c) as the literature reported. However, the first growing mode is very difficult to obtain and it is the most desired situation. See K. R. Kloetstra, H. W. Zandbergen, J. C. Jansen, H. van Bekkum, Microporous Mater. 1996, 6: 287-293.

Mesoporous films reported in the literatures so-far can be grown mainly according to mode b and c, in which TEOS and acidic solution of cetyltrimethyl-ammonium chloride were mixed, and then nucleated on the surface of fresh dissociated mica at a temperature of 80° C. to obtain oriented-grown and continuous mesoporous silica film with oriented channels parallel to the mica surface. (Yang P., Zhao D., Margolese D. I., Generalized synthesis of large pore mesoporous metal oxides with semicrystalline frameworks, Nature, 1998, 396: 152-155.)

As the channel shapes of the obtained tubular mesoporous materials, the mesoporous channels obtained herein are perpendicular to the surface of calcium carbonate used as inorganic templates, as shown in FIG. 5. Since the diameter of mesoporous channel obtained by XRD is substantively the same as the length of two molecule chains of CTMAB, the final result is that silica is coated on the outer surface of CTMAB micelles, and then hexagonal phases are formed through self-assembly, despite the interaction between silica and the surfactant and the process. Otherwise, the remaining space, after removing organic surfactant by calcination or chemical treatment, could not generate mesoporous channels in all the processes of preparing mesoporous materials.

The following mechanism can have a reasonable explanation for the experimental phenomena. The synthesis route of hollow mesoporous material is shown in FIG. 12. Without being bound by any particular theory, and in view of the crystal template mechanism, the possible growth mechanism for the formation of mesoporous silica film on calcium carbonate templates is as follows:

(1) Calcium carbonate as the inorganic template 10 in the suspension has a small size and a high surface energy, thereby adsorbing the surfactant CTMAB. When CTMAB is enriched on the surface of calcium carbonate, the concentration of CTMAB on the surface of calcium carbonate is higher than that in bulk liquid phase, reaching the second critical micelle concentration (cmc2).

(2) The surfactant CTMAB micelles 20 will be perpendicular in axial direction to the surface 12 of calcium carbonate by means of complicated synergistic effects such as weak non-covalent bond of smaller directionality, such as coulomb's force, hydrogen bond, steric hindrance, van der waals force and weak ionic bond or ionic strength, and forms hexagonal arrays through self-assembly according to the lowest energy principle.

(3) Under the alkaline condition, a silicon source such as TEOS is hydrolyzed to generate silicic acid oligomer having multiple coordination sites, which fills, agglomerates and deposits around the hexagonal array micelles to generate the shell 30 as the framework thickness of MCM-41.

(4) A calcination treatment at 550° C. decomposes the micelles 20 of the surfactant such as CTMAB, which is used as an organic template, into gases, thereby leaving mesoporous channels 40 in the shell 30. After inorganic template 10 of calcium carbonate is dissolved in HCl solution, the reaction products of CaCl₂ and CO₂ diffuse out of mesoporous channels, and thereby forming mesoporous materials 50 with hollow structure.

The thin-shell type of mesoporous material in the present invention has short mesoporous channels with a small diffusion resistance, which helps to transfer the reactive substance. In particular, it is very suitable for preparing egg-albumen type catalyst loaded with noble metal.

The present invention is further illustrated by the following examples, which are not intended to limit the scope of the invention.

### EXAMPLE 1

### Preparation of Thin-Shell Type of Mesoporous Nanospheres

8.7 g of cubic CaCO₃ powders with a particle diameter of 40 nm were added to 50 g of de-ionized water. 2.5 g of CTMAB, 13.2 g (about 15 ml) of analytical pure aqueous ammonia (25 wt %) and 60 g of ethanol were then added in sequence. After stirring the mixture at a speed of 300 rpm for 15 minutes, tetraethylorthosilicate (TEOS) was added with the ratio of SiO₂/CaCO₃=0.15 (by weight) and the suspension was stirred for another 2 hours. The mixture was then filtered, and the filter cake was rinsed with ethanol, dried at 90° C. in muffle furnace, and calcinated at 550° C. for 5 hours. The templates were dissolved with a dilute hydrochloric acid, and pH is maintained below 1, and finally dried to obtain the product.

### EXAMPLE 2

### Preparation of Mesoporous Hollow Tubes

8.7 g of needle-like CaCO₃ powders with a diameter of 200-300 nm and an aspect ratio of 5 were added into 50 g of de-ionized water. 2.5 g of CTMAB, 13.2 g (about 15 ml) of analytical pure aqueous ammonia (25 wt %) and 60 g of ethanol were then added in sequence. After stirring the mixture at a speed of 300 rpm for 15 minutes, tetraethylorthosilicate (TEOS) was added with the ratio of SiO₂/CaCO₃=0.2 (by weight) and the suspension was stirred for another 2 hours at a room temperature. The mixture was then filtered, and the filter cake was rinsed with ethanol, dried at 90° C. in a muffle furnace, and calcinated at 550° C. for 5 hours. The templates were dissolved with a dilute hydrochloric acid, and pH is maintained below 1, and finally dried to obtain the product.

### EXAMPLE 3

### Preparation of Thin-Shell Type of Mesoporous Nanospheres

10 g of spherical BaCO₃ powders with a diameter of 100 nm were added to 50 g of de-ionized water. 3 g of CTMAB, 13.2 g (about 15 ml) of aqueous ammonia (25 wt %) and 60 g of ethanol were then added into the suspension in sequence. After stirring the mixture at a speed of 300 rpm for 15 minutes, tetraethylorthosilicate (TEOS) was added with the ratio of SiO₂/CaCO₃=0.2 (by weight) and the suspension was stirred for another 2 hours at a room temperature. The mixture was then filtered, and the filter cake was rinsed with ethanol, dried at 90° C., and calcinated at 550° C. in a muffle furnace for 5 hours. The templates were dissolved with a dilute hydrochloric acid, and pH is maintained below 1, and finally dried to obtain the product.

Although the present invention has been described with reference to specific examples, the skilled person in the art will recognize that changes may be made in form and detail without departing from the spirit and scope of the invention.

1. A hollow-structured mesoporous silica material comprising a hollow silica particle that has a shell having a plurality of channels oriented substantially perpendicular to the inner surface of the shell.

2. The mesoporous silica material according to claim 1 wherein the hollow-silica particle has different shapes selected from the group consisting of spherical, needle-like, cubic, spindle, petal-like, laminar and fibroid shapes.

3. The mesoporous silica material according to claim 1 having a diameter of from 15 to about 500 nm.

4. The mesoporous silica material according to claim 3, having a diameter of from 40 to about 150 nm.

5. The mesoporous silica material according to claim 4, having a diameter of from 50 to about 120 nm.

6. The mesoporous silica material according to claim 1 wherein the shell has a substantially uniform thickness of from 5 to about 500 nm.

7. The mesoporous silica material according to claim 6, having a thickness of from 8 to about 20 nm.

8. The mesoporous silica material according to claim 7, having a thickness of from 10 to about 15 nm.

9. The mesoporous silica material according to claim 1 wherein the channels have an average pore diameter of from 2 to about 50 nm.

10. The mesoporous silica material according to claim 9 wherein the channels have an average pore diameter of from 2 to about 10 nm.

11. A process for preparing a hollow-structured mesoporous silica material comprising a hollow silica particle that has a shell having a plurality of channels oriented substantially perpendicular to the inner surface of the shell, comprising the steps of:
(1) adding a surfactant that can form rod-shaped micelles, into an aqueous suspension of inorganic templates made from an inorganic salt selected from the group consisting of calcium carbonate, magnesium carbonate and barium carbonate, and then adding an organic solvent;
(2) adding a source of silicon into the mixture obtained in the step (1) under an alkaline condition;
(3) filtering the mixture obtained in step (2), then drying and calcinating the filtrate, to obtain a mesoporous silica material containing the inorganic template; and
(4) adding the mesoporous silica material containing the inorganic template into an acid to gain the hollow-structured mesoporous silica material.

12. The process according to claim 11 wherein the organic solvent is selected from ethanol or methanol.

13. The process according to claim 11 wherein the inorganic template has a diameter of from 10 to about 500 nm, preferably.

14. The process according to claim 13 wherein the diameter of the template is from 30 to about 300 nm.

15. The process according to claim 13 wherein the diameter of the template is from 50 to about 150 nm.

16. The process according to claim 11 wherein silicon source is an aqueous solution containing silicon or a combination of inorganic compounds containing silicon, selected from an inorganic silicate such as sodium silicate and organic silicate such as orthosilicate ester.

17. The process according to claim 16 wherein the silicon source is tetraethylorthosilicate.

18. The process according to claim 11 wherein the surfactant is selected from the group consisting of a cationic surfactant of long-chain alkyl quaternary ammonium salts with low molecular weight CₙH₂ₙ₊₁NMe₃X, wherein n=from 10 to about 22, X=Br—, Cl— or OH—; a surfactant with multi-functional groups NH₂(CH₂)ₙNH₂, wherein n=from 10 to about 22; and a surfactant with high molecular weight selected from PEO-PPO-PEO, and a nonionic Gemini surfactant.

19. The process according to claim 18 wherein the cationic surfactant is cetyltrimethylammonium halide, such as cetyltrimethylammonium bromide

20. Use of a hollow-structure mesoporous silica material according to claim 1 in the preparation of catalyst, pesticide and optical fiber.
